(19) United States
(12) Patent Application Publication
(10) Pub. No.: US 2006/0205391 A1
(43) Pub. Date: Sep. 14, 2006

(54) TELECOMMUNICATIONS APPARATUS

(75) Inventor: Jeffrey Wilson, Fareham, Hampshire (GB)

Correspondence Address: RENNER OTTO BOISSELLE & SKLAR, LLP, 1621 EUCLID AVENUE, NINETEENTH FLOOR, CLEVELAND, OH, 44115, US

(73) Assignee: INTELLPROP LIMITED, Guernsey, Channel Island (GB)

(21) Appl. No.: 11/420,235

(22) Filed: May 25, 2006

Related U.S. Application Data
(63) Continuation of application No. 10/398,683, filed on Jul. 31, 2003.

(30) Foreign Application Priority Data
Oct. 9, 2000 (GB) 0024730.4

(51) Int. Cl. H04L 12/58

(52) U.S. Cl. 455/412.1

(57) ABSTRACT

In a telecommunications apparatus. a control processor (CSRS) receives a call request from a caller's terminal and establishes a call with a voice messaging system (VM). Signals from the voice messaging system (VM) and from the caller's terminal are combined and sent to the called party (user) upon receipt of an acceptance signal from the called party. If desired, the conversation between the caller and called party may be recorded by a recording apparatus.

This application is a continuation of U.S. patent application Ser. No. 10/398,683 filed on Jul. 31, 2003, which is a national phase of International Application No. PCT/GB/2001/04496 filed Oct. 9, 2001 that was published in the English language, both of which are hereby incorporated herein by reference in their entireties.

This invention relates to telecommunications apparatus, and in particular to such apparatus for establishing telecommunications calls upon receiving call requests.

When a mailed letter is received, the envelope may provide an initial indication of the sender and the contents of the letter. For example, a company name or logo may be present, or the handwriting or postmark may be recognised if the letter is from a friend or family member.

The recipient, who may be busy on other tasks or have a ‘full in-tray’, can decide whether to open the envelope immediately or defer it until later.

If the decision is made to open the envelope, then at a glance the reader can confirm the sender and also determine the contents of the letter. Again, a decision can be made to read the letter immediately, defer it until later, or even discard it.

Once the letter has been read the recipient has further choices—file it, send or copy it to somebody else or throw it away.

When a telephone call is received, usually on mobile phones, and sometimes on fixed network phones, the Calling Line Identity (CLI) is displayed. This may be in the form of a telephone number or, when the number has been stored in the receiving handset's memory or ‘phone book’, it may be an alphanumeric identification of the caller.

The CLI display is analogous to any identification that may be obtained from information on an envelope, and assists the recipient in deciding whether to answer the call immediately or allow it to go to an answering machine or voicemail system.

When a recipient, particularly in a domestic situation, has an answering machine on the premises, it is often possible to listen, via the loudspeaker on the answering machine, to the message being deposited by the caller. If the call is important the recipient can pick up the telephone handset and immediately speak to the caller. The answering machine will normally stop recording when the handset is lifted.

This form of call screening, which is analogous to opening the envelope, identifying the sender and/or the topic of letter and immediately reading it all, is of particular use when the recipient does not have a CLI display or does not recognise the number shown, or when CLI is not available or is withheld.

Although it is possible to conceive of a mobile handset that incorporates an answering machine that would allow a similar form of call screening to take place, mobile phone users who wish to have messages recorded when they' do not or cannot answer calls utilise voicemail system facilities within the network. Some fixed network phone users also make use of network-based voicemail systems.

Of course, it is possible that equipment could be placed within the telephone network, in front of a voicemail system to provide a screening facility. When a call is routed to the voicemail system via the screening equipment, the latter would outdial to the recipient (mailbox owner), announcing that it is a screened call and allowing the voicemail recording to be monitored. If the recipient wishes to speak immediately to the caller, a simple command (e.g. DTMF keypress) would be detected by the screening equipment which would connect the two parties together. The link to the voicemail system would normally be dropped at this time as there would be little point in just recording speech from the caller.

It can be seen, therefore, that methods are available, or could be made available, to enable phone users to screen their calls and once the caller or subject is identified to answer them immediately.

Now, returning to the analogy with written correspondence, which can be passed on to other readers, copied and/or filed, equipments, particularly voicemail systems, are available to copy or redirect voice messages to other parties' voice mailboxes and even to reply messages during other phonecalls. Some systems also offer the facility to deliver recorded messages by e-mail which enables them to be distributed to other e-mail users and stored and used within other computer systems.

However, these facilities relate to ‘messages’, i.e. they are not dialogues or conversations.

The difficulty in recording telephone conversations, particularly with a mobile handset, is that there are two separate audio paths—to and from the handset—and to obtain a representative recording it is necessary to add the two channels. This summation is not available within the mobile handset and handsets do not provide external outputs with these signals.

This is unfortunate, because the ability to save and later refer to telephone conversations may be highly desirable in many circumstances. For example:

business users may wish to record conversations with customers or suppliers, either to keep as a file copy or to play to colleagues;

business users may wish to disseminate information in telephone conversations with colleagues to other people in the organisation;

mobile users are not always in a position to make notes during important conversations, particularly in the car. The ability to refer back to the conversation later would make it easier to have detailed discussions, make decisions, etc. in these circumstances;

private users may wish to record conversations with travel agents, estate agents, etc. in case of subsequent dispute;

it may be desired to record conversations with family members, particularly announcing special or momentous events, both for reply to other family members and to keep for sentimental reasons.

At present, if a telephone call is not answered then it is common for the caller to be recorded on either an answerphone or a voicemail system. In this situation there is only one caller and the recording facility is used as a method for leaving audio messages for the person you wanted to contact. It is not unusual for telephone answering machine users to listen to the caller for a while and then decide whether they want to pick up the telephone and talk to the caller. However, once the phone is picked up the recording machine usually stops.

Telephone conversations are routinely recorded by financial institutions to provide evidence of the particular transaction which has taken place. This is to protect the financial institution and also to some extent the customer. The audio recording can provide evidence of what was actually said. Similarly, call centres and telemarketing organisations may record calls, particularly for quality control and training purposes. However, these are expensive installations, and not normally available to individuals or other sectors of society.

Another example of caller recording is disclosed in UK patent application Publication No. 2 353 663 A. This system provides a mechanism for a user to dial a telephone number, have that telephone call recorded and receive the recording by e-mail.

According to the invention there is provided a telecommunications apparatus for a mobile telephone system, the apparatus comprising

a control processor operable to receive a call request representing a request from a calling terminal to establish a telecommunications call via said apparatus with a telecommunications terminal to be called, said called terminal being identified in said call request by a called terminal identifier, said control processor being operable in response to said call request to establish a call with a voice messaging system,

a combiner operable to receive and to combine first telecommunications signals from said voice messaging system and second telecommunications signals from said calling terminal,

a recording apparatus operable to record said combined first and second telecommunications signals, wherein said control processor is operable

to establish a call to said called terminal and to communicate to said called terminal said combined first and second telecommunications signals, and

consequent upon receipt of an acceptance signal from said called terminal, to establish said requested call between said calling terminal and said called terminal.

Embodiments of the invention provide a simple, cost-effective means of screening telephone calls and providing high quality recordings of telephone conversations.

The invention will now be described by way of example with reference to the accompanying drawings, throughout which like parts are referred to by like references, and in which:

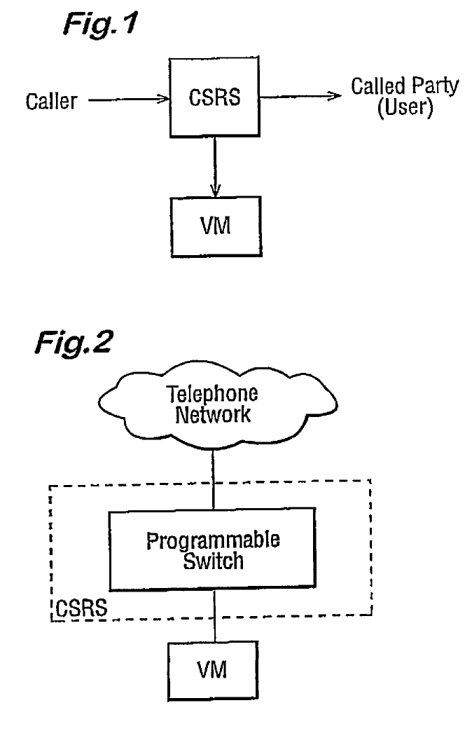

FIG. 1 is a system schematic block diagram of a telephone call screening and recording system according to an embodiment of the invention;

FIG. 2 is a more detailed block diagram of the telephone call screening and recording system;

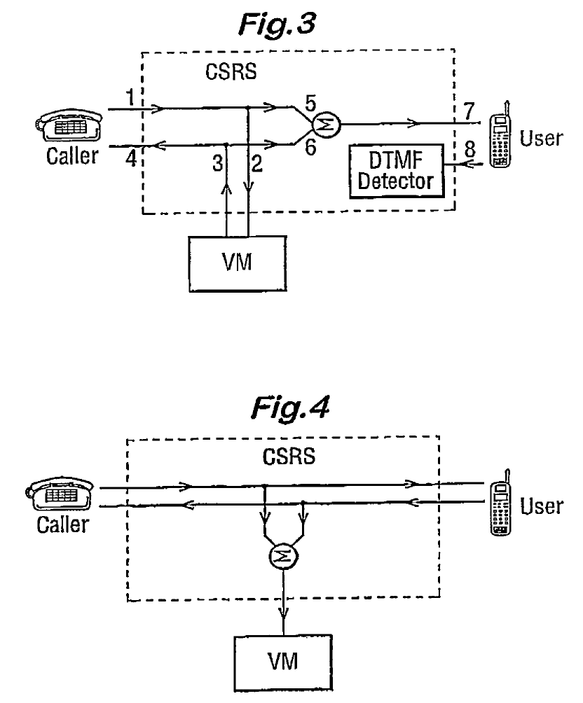

FIG. 3 shows the configuration of the system of FIG. 2 during call screening;

FIG. 4 shows the configuration of the system of FIG. 2 during call recording;

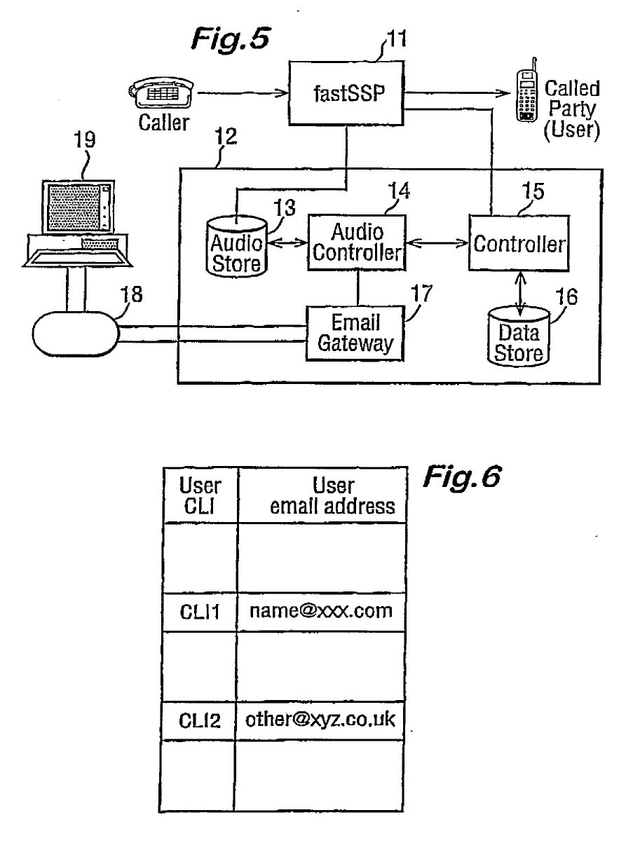

FIG. 5 is a block diagram of a system implementation including audio recording and delivery; and

FIG. 6 is a users'database which may be included in the system.

One embodiment of a telephone call screening and recording system is shown in FIG. 1. The telephone call screening and recording system CSRS has input and output connections to the telephone network, allowing access for a caller and to a called party (user), and an output connection to a voicemail system VM.

Users may subscribe to the service or a network operator may choose to provide it as a standard feature for all voicemail users, for example.

When the service is activated for a user the network automatically routes all incoming calls for that user to CSRS. The service may be activated permanently or on demand by the user, e.g. by unconditionally directing all calls to CSRS.

An incoming call is routed through CSRS to the voicemail system (VM) which will answer with a greeting and invitation to record a message. At the same time as CSRS puts the call through to VM it also makes a separate outdial call to the user (called party). The user is informed, by means such as the displayed CLI (assuming that the handset has that capability), display of USSD (Unstructured Supplementary Service Data) message on a mobile handset, and/or by voice announcement after the call is answered, that it is a screened call.

Meanwhile, the caller is connected to VM and CSRS is performing a summation of the two audio channels (transmit and receive). Once the user is aware that a screened call is in progress the summed output is switched through to the user who can listen to both the greeting from VM and the caller recording a message.

Now, if the user wishes to speak to the caller immediately, a single key'press causes the CSRS to instantly re-configure its routings so that the caller and user are directly connected. In normal circumstances the connection to VM is broken, thus freeing that system to take additional calls.

However, the user also has the optional facility to record the conversation with the caller. This service is requested by a different key press when the call is accepted. In this case, as well as connecting the caller and user together the two audio paths between them are fed into the summing circuit to provide a single feed into VM, which continues its recording.

A key feature of the system is therefore the summation facility of CSRS, and the ability to instantly re-configure its connections so that its use can be varied on demand.

A preferred embodiment of the call screening and recording system (CSRS) is shown in FIG. 2.

As shown in FIG. 2, CSRS connects between the telephone network and the voicemail system VM. The voicemail system may be a new equipment installed specially to support this new service or it may be existing equipment providing a standard voicemail service. A key benefit of the system is that a basic service can be provided merely by inserting the CSRS in front of an existing voicemail system—no modifications are required to either the telephone network or the voicemail system.

CSRS may comprise a programmable switch, such as the Ocean fastSSP (service switching point) programmable switch incorporating summation functionality, as manufactured by Telsis Limited.

FIGS. 3 and 4 show the CSRS configuration for audio paths during call screening and call recording respectively. In these figures, the caller is shown as being on the fixed network and the user (called party) is shown as being on the mobile network; however the system could work with any combination of fixed and mobile phones.

In FIG. 3, the call from the mobile has been automatically diverted to CSRS. CSRS connects the call to voicemail (VM) with audio paths 1, 2 and 3, 4; as far as the caller is concerned, the call has been answered just by voicemail. However, CSRS also monitors both audio paths, feeding them via paths 5. 6 into the summation function. The output 7 of the summer is fed to the user's mobile phone—a call to the user having been automatically established by CSRS when the incoming call was routed to VM. The audio path 8 from the user is routed only to a DTMF detector within CSRS. In this way, the user hears the ‘dialogue’ between the caller and VM, but cannot be heard by either.

Now, if the user wishes to speak to the caller immediately, they press a DTMF key, e.g. star. The CSRS DTMF detector recognises the keypress and informs the application programme within CSRS.

CSRS instantly changes the internal routings so that there are direct audio connections in both directions between the caller and user. The summation function is disconnected, as is VM.

However, if the user wishes to speak to the caller immediately and also record the conversation, they press a different DTMF key, e.g. hash. CSRS detects the keypress and again instantly changes the internal routings to provide direct audio connections in both directions between the caller and user but also taps-off each path to provide inputs to the summation function. The summer output is fed into VM so that the conversation is recorded. The configuration is shown in FIG. 4.

In the event that the user accepts a screened call and talks immediately to the caller but without recording the conversation, it is likely that the voicemail or recording system will have already started recording a message from the caller. In this instance, it is likely that the recording will not be required and desirable that it be automatically deleted so that, for example, the user is not alerted that there is a message waiting. This may be accomplished by some form of signalling between CSRS and VM.

The embodiment described above can form the basis of a system offering enhanced services to phone users, in which incoming calls would be pre-classified according to their Calling Line Identity (CLI) and handled accordingly.

Each user (subscriber) to the service may register the CLI of a number of callers, with each CLI being accorded a status. The registered CLIs and their categorisations are stored in a database within the system. When a call arrives the database is interrogated to determine how the system should handle the call.

In one embodiment there are four categories of callers:

A call from A-list caller connected straight through to the user;

B call form B-list caller connected straight through to the user and also recorded;

C call from C-list caller connected initially to voicemail, with a simultaneous call being made to the user for screening. The user then has the opportunity of accepting the call for an immediate conversation with the caller, with or without recording, or rejecting it, leaving the caller connected to voicemail;

D call from D-list caller connected directly to voicemail.

The user can also decide how calls should be classified and handled when no CLI is provided by the network. For example, calls with CLI withheld could be treated as D-list calls and routed only to voicemail, whilst calls with CLI unavailable (which may include international calls) could be classified as C-list and routed to both voicemail and the user for screening.

In certain cases a user may take a call from an A-list caller, which is directly connected straight through, and then decide that they would like a recording of the call. A command from the user to the CSRS implementation could initiate immediate recording. This could easily be achieved if the call recording function is an integral part of an enhanced CSRS. If a standard, legacy voicemail system is in use it would be desirable to have a secondary mailbox access number for the user through which recording would occur immediately on call answer, i.e. there would be no greeting and prompt to record a message as with normal voicemail access.

The command from the user to record the call could be by DTMF keypress—this is a simple and effective method but may be intrusive in that the keypress would normally be heard by the caller and may provide an undesirable alert to the fact that recording is taking place. In some implementations the CSRS could filter out DTMF tones in the audio passing from user to caller.

Alternatively, a non-intrusive command could be used where the handset and network support such functionality. For example, an ISDN handset may support mid-call messaging via the data channel. On a mobile handset, mechanisms such as SMS (Short Message Service) or USSD (Unstructured Supplementary Service Data) already allow non-intrusive messages to be sent. SMS may be a less appropriate method in this case because message composition and sending is generally more complicated and also because SMS normally uses a store-and-forward transmission system. However USSD offers a powerful mechanism for quickly and simply sending a command. With appropriate routing within the mobile network a USSD command could be sent to CSRS to initiate recording.

A, B, C and D-lists may be set up within a system database by the user in a variety of ways including:
manually, via a customer service agent
via a web interface
via an interactive voice service
via SMS messaging
via WAP (Wireless Application Protocol) messaging
via e-mail.

The recorded conversations may be accessed by dial-up means as with standard voicemail systems—thus the user can listen to the recordings, and if the system functionality allows it, forward the recordings to the mailboxes of other users.

The embodiment described above can form the basis of a system offering further enhanced services to phone users. Whilst CSRS can be used in conjunction with an existing voicemail system, there may be advantages in implementing a new audio recording and delivery system closely integrated with the fastSSP. Such a system could offer e-mail delivery of recorded conversations to facilitate handling, distribution and storage.

An enhanced implementation is shown in FIG. 5. As shown, the caller is on a fixed phone and the user (called party) is on a fixed phone. However, the system may be operated with any combination of fixed and/or mobile phones.

Referring to FIG. 5, an incoming call is handled by the fastSSP 11 as described above. When the user requests recording, either explicitly through DTMF keypress or (in some implementations) through inclusion of the caller's CLI in the B-list or D-list, the summed output of the audio paths is sent via a separate call to an audio recording and delivery system 12.

An audio store 13 in the audio recording and delivery system 12 records the whole of the telephone conversation between the two parties. The user's CLI is passed to a controller 15. The controller 15 extracts the user's e-mail address from a data store 16 and associates it with the audio recording. Either automatically as soon as the recording is completed, or on request at some point in the future, the user may wish to deliver the audio recording via e-mail. In this case, the audio is extracted from the audio store 13 by an audio controller 14 and is delivered to an e-mail gateway 17, then to an e-mail server 18 and hence to the user's PC 19 as an attachment to a standard e-mail.

The details of the e-mail delivery of audio are included in UK patent application Publication No. 2 353 663 A, and so the mechanisms for choice of e-mail delivery are not shown in FIG. 5.

The user's e-mail address may be registered in a variety of ways, including manual process involving customer service agent
via a web interface
via an interactive voice service
via SMS messaging
via WAP (Wireless Access Protocol) messaging
via e-mail.

The information may be held in the data store 16 in a form as shown in FIG. 6.

As an alternative implementation the audio summation function could be provided in the audio recording and delivery system—the fastSSP 11 would provide two separate audio feeds rather than one.

A major benefit of embodiments of this invention is that the user has a great deal of control over the way in which incoming calls are handled. Interruptions can be minimised and when a call does arrive at the handset, the recipient knows that it has already been categorised.

1. A telecommunications apparatus for a mobile telephone system, the apparatus comprising
a control processor operable to receive a call request representing a request from a calling terminal to establish a telecommunications call via said apparatus with a telecommunications terminal to be called, said called terminal being identified in said call request by a called terminal identifier, said control processor being operable in response to said call request to establish a call with a voice messaging system,
a combiner operable to receive and to combine first telecommunications signals from said voice messaging system and second telecommunications signals from said calling terminal,
a recording apparatus operable to record said combined first and second telecommunications signals, wherein said control processor is operable
to establish a call to said called terminal and to communicate to said called terminal said combined first and second telecommunications signals, and
consequent upon receipt of an acceptance signal from said called terminal, to establish said requested call between said calling terminal and said called terminal.

2. A telecommunications apparatus as claimed in claim 1, wherein, afier said requested call has been established between said called terminal and said calling terminal, said combiner is operable to combine further signals communicated between said called terminal and said calling terminal, and said recording apparatus is operable to record the combined further signals.

3. A telecommunications apparatus as claimed in claim 1, wherein the control processor is operable, upon receipt of either a first or a second acceptance signal from said called terminal, to establish said requested call between said calling terminal and said called terminal and, upon receipt of the second acceptance signal from said called terminal, additionally to control said combiner to combine further signals communicated between said called terminal and said calling terminal, and to control said recording apparatus to record the combined further signals.

4. A telecommunications apparatus as claimed in claim 1, comprising a data store arranged to store at least one terminal identifier in association with said called telecommunications terminal, wherein said control processor is operable
to establish said requested call between said calling terminal and said called terminal consequent upon whether a terminal identifier of said calling terminal is present in said data store in association with said called terminal.

5. A telecommunications apparatus as claimed in claim 4, wherein said control processor is operable to store a plurality of terminal identifiers in said data store, each of which is assigned to one of a plurality of categories, a first of said categories defining calling terminal identifiers for which calls may be established on request from said calling terminal with said called terminal, and a second of said categories defining calling terminal identifiers for which calls may not be established on request from said calling terminal and said called terminal, call requests from said second category being established with said voice messaging system.

6. A telecommunications apparatus as claimed in claim 5, wherein said plurality of categories further includes a category for which said recording apparatus is disabled.

7. A telecommunications apparatus as claimed in claim 1, wherein said control processor is operable to store in said data store, an address associated with said called terminal at which address said recorded combined telecommunications signals represented as digital data may be received, wherein said control processor is operable upon termination of said call,
to retrieve from said data store said address associated with said called telecommunications terminal which has been pre-stored,
to represent said recorded combined telecommunications signals as digital data signals, and
to communicate with digital signals to said address.

8. A telecommunications apparatus as claimed in claim 7, wherein said address is an e-mail address.

9. A telecommunications apparatus as claimed in claim 1, wherein said control processor is operable to communicate said calling terminal identifier to said called terminal.
